(19) United States
(12) Patent Application Publication
(10) Pub. No.: US 2011/0085504 A1
(43) Pub. Date: Apr. 14, 2011

(54) ADAPTIVE BEAM-FORMING AND SPACE-FREQUENCY BLOCK CODING TRANSMISSION SCHEME FOR MIMO-OFDMA SYSTEMS

(76) Inventors: Chia-Chin Chong, Santa Clara, CA (US); Hlaing Minn, Allen, TX (US); Fujio Watanabe, Union City, CA (US)

(21) Appl. No.: 12/899,394

(22) Filed: Oct. 6, 2010

Related U.S. Application Data
(60) Provisional application No. 61/251,428, filed on Oct. 14, 2009.

(51) Int. Cl. H04W 72/00

(52) U.S. Cl. 370/329

(57) ABSTRACT

In a wireless communication system including a base station and multiple mobile stations, a method transmits an orthogonal frequency division multiple access (OFDMA) data frame to the mobile stations. The method includes the steps of (a) at the beginning of the data frame, collecting metrics representing channel conditions for each of the channels; (b) assigning each mobile station to one or more communication channels based on the metrics collected; (c) for each symbol in the frame, calculating an average bit-error-rate for each of a number of transmission modes, and assigning to that symbol the transmission mode corresponding to the lowest calculated average bit-error-rate for that symbol; and (d) transmitting the symbols in the frame according to their respective assigned transmission mode. In addition, a bit-loading optimization step may be carried out in conjunction with the method to determine a modulation order for each symbol to be transmitted.

### CROSS REFERENCE TO RELATED APPLICATIONS

The present invention relates to and claims priority of U.S. provisional patent application (“Provisional Application”), Ser. No. 61/251,428, entitled “An Adaptive Beamforming and Space-Frequency Block Coding Transmission Scheme for MIMO-OFDMA Systems,” filed on Oct. 14, 2009. The Provisional Application is hereby incorporated by reference in its entirety.

### BACKGROUND OF THE INVENTION

1. Field of the Invention

The present invention relates to high data rate wireless communication. In particular, the present invention relates to high data rate wireless communication using beam-forming and coding schemes.

2. Discussion of the Related Art

Wireless communication systems are developing in the directions of higher data rates and more reliable communication in diverse propagation environments. An important aspect of a good communication system design is efficient utilization of available diversity in the system. The principles of multiple-input-multiple-output (MIMO) and orthogonal frequency division multiple access (OFDMA) allow a flexible system design in which frequency and spatial diversities of the channel can be exploited. When the channel is frequency-selective, frequency diversity can be exploited by assigning each mobile station (MS) to its best channel out of the available subchannels (also known as “multiuser diversity”). On the other hand, multiple antennas can be used in a variety of ways to improve the link quality. For example, when channel knowledge at the transmitter is available, beam-forming (BF) and precoding techniques provide array gain. Alternatively, space-frequency coding schemes can be exploited for spatial diversity in the channel without requiring channel information at the transmitter.

Channel information can be acquired either through feedback from the receiver in both frequency-division duplex (FDD) and time-division duplex (TDD) systems or by measuring the uplink channel in a TDD system. At the transmitter, channel knowledge imperfections due to estimation errors, quantization errors, or feedback delays are important factors affecting a system design. In recent years, researchers have focused on optimizing multiple antenna transmission with imperfect channel knowledge at the transmitter. Such studies are published, for example, in (a) “Transmitter optimization and optimality of beamforming for multiple antenna systems,” S. A. Jafar and A. Goldsmith, IEEE Trans. Wireless Commun., vol. 3, no. 4, pp. 1165-1175, July 2004; (b) “Space-time transmit precoding with imperfect feedback,” by E. Visotsky and U. Madhow, IEEE Trans. Inform. Theo., vol. 47, no. 6, pp. 2632-2638, September 2001; (c) “Robust transmit eigen beamforming based on imperfect channel state information,” by A. Abdel-Samad, T. N. Davidson and A.-B. Gershman, IEEE Trans. Sig. Process., vol. 54, no. 5, pp. 1596-1609, May 2006; and (d) “Robust power allocation designs for multiuser and multiantenna downlink communication systems through convex optimization,” by M. Payaro, A. Pascual-Inserte and M. A. Lagunas, IEEE Journal Select. Area. Commun., vol. 25, no. 7, September 2007. These examples illustrate optimum transmission strategies when partial channel knowledge is available at the transmitter.

Alternatively, space diversity schemes may be combined with BF to provide robust transmission based on channel quality. Examples of such an approach are reported, for example, in (a) “Combining beamforming and orthogonal space-time block coding,” by G Jongren and M. Skoglung, IEEE Trans. Inform. Theory, vol. 48, no. 3, pp. 611-627, Mar. 2002; (b) “Optimal transmitter eigen-beamforming and space-time block coding based on channel mean feedback,” by S. Zhou and G B. Giannakis, IEEE Trans. Sig. Process., vol. 50, no. 10, pp. 2599-2613, October 2002; and (c) “Combining beamforming and space-time coding using quantized feedback,” S. Ektabani and H. Jafarkhani, IEEE Trans. Wireless Commun., vol. 7, no. 3, pp. 898-908, March 2008. In BF space diversity schemes, a quasi-static fading assumption is made in which the channel is considered fixed throughout the frame. Hence, these analyses are based on constant channel imperfection, which may not be valid for a long frame or at high Doppler frequencies. In fact, varying channel imperfection conditions are often experienced by mobile users.

Numerous techniques have been reported which focus on either a space-time coding or space-frequency coding design, or a BF design. However, a design which switches between space-frequency coding and BF within a transmission frame is not known. For instance, U.S. Pat. No. 7,522,673, entitled “Space-time coding using estimated channel information,” to G. Giannakis, S. Zhou, issued on Apr. 21, 2009, discloses techniques for space-time coding only in a wireless communication system with multiple transmit antennas. In such a system, the transmitter uses channel information fed back from a receiver.

U.S. Patent Application Publication 2008/0144738, entitled “Beam space time coding and transmit diversity,” by A. Naguib, filed on Jun. 19, 2008, discloses methods and apparatus for increasing diversity gain at a receiver by applying BF to transmit diversity space-time coded signals. Using this technique, transmit diversity can be exploited at a signal source by space-time coding the signal. A transmit signal is space-time coded over multiple space-time antenna groups that are each associated with a specific space-time code. The signal at each space-time antenna group is then beam-formed over the antennae in the space-time antenna group. Each antenna in a space-time antenna group is weighted with a distinct weight, relative to other antennae in the space-time group.

U.S. Patent Application Publication 2008/0101493, entitled “Method and system for computing a spatial spreading matrix for space-time coding in wireless communication systems,” by H. Niu, C. Ngo, filed on May 1, 2008, discloses a method and system for wireless communication that combine space-time coding with statistical transmit BF. The statistical transmit BF uses an optimal spreading matrix as a function of a transmit correlation matrix, without requiring instantaneous channel state information (CSI). In a high mobility environment, the wireless channel gains can vary within the transmission frame, causing substantial performance degradation in BF approaches.

However, the techniques discussed above do not address channel temporal variations within the transmission frame, and hence suggest neither the desirability of, nor the means for, a switching mechanism between space-time coding and BF within a frame.

U.S. Pat. No. 7,280,604, entitled “Space-time doppler coding schemes for time-selective wireless communication channels,” to G Giannakis, X. Ma, issued on Oct. 9, 2007, discloses, for time-selective and high Doppler spread channels, a space-time Doppler (STDO) coding technique. In particular, a STDO coded system is capable of achieving a maximum Doppler diversity for time-selective frequency-flat channels. U.S. Pat. No. 7,224,744, entitled “Space-time multipath coding schemes for wireless communication systems,” by G. Giannakis, X. Ma, issued on May 29, 2007, discloses space-time multipath (STM) coding techniques for frequency-selective channels. The described STM coded system guarantees full space-multipath diversity, and achieves large coding gains with high bandwidth efficiency. Despite frequency diversity in the STM, however, none of the techniques disclosed are able to exploit frequency and multiuser diversities simultaneously.

U.S. Patent Application Publication 200/0227249, entitled “Adaptive transmission method and a base station using the method” (“Ylitalo”), by J. Ylitalo, filed on Sep. 10, 2009, relates to a technique for selecting a spatial transmission method for a next downlink transmission in a BS. In Ylitalo, the BS makes a selection between BF, space-time coding (STC) or MIMO for a next downlink frame. The selection is based on uplink measurements and feedback from a particular MS to which the next downlink frame is to be transmitted. Ylitalo, however, does not consider channel temporal variations within the transmission frame which represents high mobility environments. As BF approaches are sensitive to channel knowledge mismatches, the channel variations within the frame will cause performance degradation under the Ylitalo's approach.

### SUMMARY OF THE INVENTION

The present invention provides numerous methods for allocating alternative multiple antenna transmission modes based on the signal-to-noise ratio (SNR), modulation order and Doppler frequency, These methods increase reliability (i.e., decrease the bit-error-rate (BER))

Unlike methods of the prior art, the methods of the present invention allow different transmission modes during a single frame, in response to channel variations within the frame. In one embodiment of the present invention, a method takes advantage of available channel knowledge in a given channel by allocating a BF transmission mode, as long as the channel knowledge remains current, but switches to a space-frequency block coding (SFBC) transmission mode, when channel knowledge becomes outdated. To be applied in these methods, approximate BER expressions are also provided for BF and SFBC that are functions of SNR, modulation order and Doppler frequency. The initial channel knowledge provides decision metrics for mode allocation throughout the frame. These methods have been shown to perform as good as the better of BF and SFBC over all SNR values.

According to a second embodiment of the present invention, a method that exploits multiuser diversity adapts rate and transmission mode across symbols in a frame, based on a channel model of a monotonically decreasing average channel power as a function of time within a frame. Such a method provides even higher performance than the BF-SFBC method discussed above, due to more efficient use of channel conditions.

The present invention is better understood upon consideration of the detailed description below in conjunction with the accompanying drawings.

### BRIEF DESCRIPTION OF THE DRAWINGS

FIG. 1 shows allocation of a frame structure in an OFDMA system, in accordance with one embodiment of the present invention.

FIG. 2 is a flowchart which illustrates the first method for allocating MIMO transmission modes conditioned upon initial channel knowledge, in accordance with one embodiment of the present invention.

FIG. 3 shows applying a bit loading algorithm after transmission mode allocation, in the second method according to one embodiment of the present invention.

FIG. 4 shows allocation of multiple-input-single-output (MISO) transmission modes conditioned upon initial channel knowledge, in the second method accordance with one embodiment of the present invention.

### DETAILED DESCRIPTION OF THE PREFERRED EMBODIMENTS

In one embodiment of the present invention, a downlink (DL) of an OFDMA wireless multi-user access network involves a transmitter having nₜ antennae, with each MS having nᵣ receive antennas. The low-pass equivalent model of a received signal by user k on subchannel q at symbol time n is given by

y^{k}(n)=H_{q,n}^{k}x_{q}^{k}(k)+w_{q}^{k}(n) (1)

where x_{q}^{k} is the transmitted signal vector for user k on subchannel q, H_{q,n}^{k} is the nᵣ×nₜ matrix of channel coefficients for user k on subchannel q (“channel matrix”), and w_{q}^{k}(n) is the nᵣ×1 noise vector. In this model, both the channel coefficients and the noise are each modeled as a random variable having a zero-mean, unit-variance, circularly symmetric, complex Gaussian distribution. Also, the noise is assumed uncorrelated across antennas and the channels are assumed statistically independent and identically distributed (iid) between different users. Therefore, the average power of the transmitted signal, E[∥x_{q}^{k}(n)∥²]=η, is also the average SNR per receive antenna.

A fast-fading channel (i.e., a channel having operating conditions that vary during a frame, but remains highly correlated during an OFDM symbol time) has effects that can be observed for a high Doppler frequency or for a long frame duration. The channel matrix H_{q,n}^{k} for a fast-fading channel at symbol time n can be modeled by:

H_{q,n}^{k}=ρₙH_{q,0}^{k}+\sqrt{1−ρ²ₙ}H_{e,q,n}^{k}, (2)

where H_{q,0}^{k} represents the channel coefficients at the beginning of the frame, H_{e,q,n}^{k} is the perturbation term due to decorrelation in the channel over n symbol times, and ρₙ is the correlation coefficient between the initial channel matrix H_{q,0}^{k} and the channel matrix H_{q,n}^{k} at symbol time n. Although the channel varies within a frame, the receiver can estimate the channel by examining the pilot symbols that are spread over the frame in the time-frequency grid. Thus, this model provides the receiver channel knowledge over the entire frame.

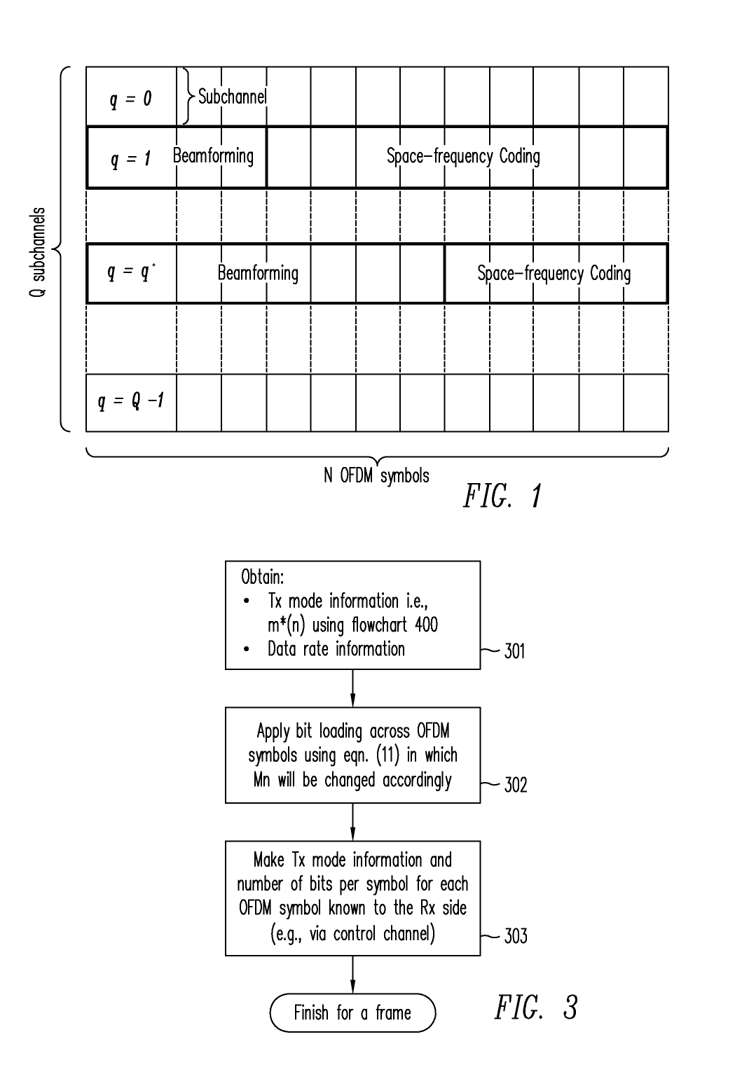

Using adaptive channel assignment, an OFDMA system can harness frequency and multiuser diversity in the propagation environment. FIG. 1 shows allocation of a frame structure in an OFDMA system, in accordance with one embodiment of the present invention. As shown in FIG. 1, the OFDMA spectrum may be divided into Q subchannels of consecutive subcarriers, and each MS may be assigned to a different subchannel depending on the channel condition it experiences. A base station (BS) can obtain channel information at the beginning of each frame to assign the channels and transmission mode selections for the MSs that are present. Assuming that the BS obtains channel information at the beginning of the frame without any time delay, a method of the present invention addresses responding to channel imperfections over the duration of the frame. Perfect channel information at the beginning of the frame is not required. For example, if channel information is known at time time μ—a negative number representing the number of symbol times preceding the beginning of the frame—one can use channel matrix H_{q,μ}^{k} in place of H_{q,0}^{k} in Equation (2) with the corresponding change in the value of ρₙ. Assuming a BS has channel knowledge H_{q,0}^{k} for all users (i.e., for q=1, . . . , Q) at the beginning of the frame, the BS may assign channels to the users without delay. Under the channel model of equation (2) above, the channel decorrelates (with respect to the initial channel knowledge) at symbol time n, according to the parameter ρₙ, which is an arbitrary correlation coefficient determined by the time-selectivity of the channel The benefits of adaptive channel assignment diminish with time as the initial channel knowledge H_{q,0}^{k} becomes outdated. Thus, frequency and multiuser diversity can be utilized for a fraction of the frame in the beginning of the frame, and the fraction depends on Doppler frequency.

In a practical system, a channel may be assigned based on, for example, the quality-of-service requirements and fairness constraints imposed by media-access-control (MAC) and scheduling protocols. Other assignment criteria can also be used, even without optimizing MAC layer protocol. In the description below, a MS is assumed always assigned to its best channel. When the context is clear that the analysis is made from the point of view of a single user, the user index k and its channel index q may be omitted. However, the single-user analysis below can be readily generalized for multiple users.

At the beginning of each frame, a BS allocates the best channel to a user and assigns a MEMO transmission mode. For single-mode BF, since the channel with the largest eigenvalue provides the best performance, the transmitter selects the channel that has the largest maximum eigenvalue. In other words, in such a system, the selected channel index q* is given by:

q*_{bf}=arg max_{q}λ_{max,q,0}, (3)

where λ_{max,q,0} is the largest eigenvalue of the matrix H_{q,0}^{k}H_{q,0}. For a SFBC transmission mode, however, the SNR-maximizing channel has the largest Frobenius norm. Therefore, the channel assignment criterion for a SFBC transmission scheme is

q*_{sfbc}=arg max_{q}∥H_{q,0}∥_{F}², (4)

where ∥•∥_{F} denotes Frobenius norm operator. In this description, the notations g_{0,bf} and g_{0,sfbc} denotes the largest eigenvalue λ_{max,q*}_{_{bf}}_{,0} under BF, and the Frobenius norm ∥H_{q*}_{_{sfbc}}_{,0}∥_{F}² under SFBC, respectively. For a single receive antenna system (e.g., in a multiple-input-single-output (MISO) system), however, the channel selection criteria is the same for both BF and SFBC. Specifically, the best channel is the one with largest Frobenius norm.

According to a first method in one embodiment of the present invention, MIMO transmission modes are allocated throughout the frame based on channel knowledge at the beginning of the frame, channel degradation coefficient, average SNR, Doppler frequency of each mobile user, and data rate. In this embodiment, for illustrative purpose, single-mode BF and orthogonal SFBC are provided as alternative transmission methods. Using its channel knowledge of all subchannels at the beginning of the frame, the BS chooses the best subchannel and determines the MIMO transmission mode for each symbol. Using channel knowledge of the selected subchannel and the correlation coefficient at each symbol, the BS computes an average BER for every symbol in the frame and allocates transmission modes at each symbol based on a minimum average BER criterion.

The following method derives, based on initial channel knowledge, an average BER for each symbol in the frame, for each of the BF and SFBC transmission modes. These BER expressions are used to select between the two transmission modes at each symbol. In this analysis, only M-ary quadrature amplitude modulated (M-QAM) signals are considered, although the method is applicable also to other modulation schemes. The BER expression for an order M modulation scheme is approximated as follows:

$${P}_{b} \approx 0.2 {e}^{\frac{3}{2 ( M - 1 )} γ} , \qquad ( 5 )$$

where γ is the per-symbol SNR. After obtaining initial channel knowledge, the average BER performances under the BF and SFBC transmission modes are calculated for a given SNR, and the appropriate MIMO transmission mode for a fixed rate transmission is selected for each symbol, based on a minimum BER requirement. The transmission modes are communicated to the MS over a control channel or message from the BS or derived by the MS using the same selection criteria.

Channel knowledge at the transmitter can be used to provide array gain such as, for example, by transmitting in the direction of the dominant eigenvector of the channel matrix. With imperfect channel knowledge, performance may degrade due to a mismatch of eigenvectors between the initial channel matrix H₀ and the actual channel matrix Hₙ. In single-mode BF, the transmitter selects BF in the direction of the largest eigenvalue of the matrix Hₙ^{H}Hₙ in order to maximize the received SNR using the dominant eigenvector. In the current system, the transmitter has channel knowledge at the beginning of the frame (i.e., at n=0 or some delay n=μ with the corresponding ρₙ). For BF, the average BER at symbol n, based on the current channel realization H₀, can be shown to be given by:

$${P}_{b}^{bf} ( n , {M}_{n} , {γ}_{0} ) \approx 0.2 {( \frac{3 ( 1 - {ρ}_{n}^{2} ) η}{2 ( {M}_{n} - 1 )} + 1 )}^{- {n}_{r}} exp ( - \frac{3 {ρ}_{n}^{2} {γ}_{0}}{3 ( 1 - {ρ}_{n}^{2} ) η + 2 ( {M}_{n} - 1 )} ) , \qquad ( 6 )$$

and therefore, the average BER over the entire frame, based on the current channel realization H₀ is given by

$${P}_{b}^{bf} ( {γ}_{0} ) \approx \frac{1}{N} {\sum }_{n = 0}^{N - 1} {P}_{b}^{bf} ( n , {M}_{n} , {γ}_{0} ) , \qquad ( 7 )$$

where N is the number of OFDM symbols in a frame, Mₙ is the M-QAM alphabet size used for the n-th symbol, and γ₀ is the SNR at symbol time n=0. γ₀ is given by γ₀=ηg_{0,bf}, where η is the average power of the transmitted signal.

As mentioned above, the SFBC transmission mode exploits spatial diversity of the channel when channel knowledge is not available at the transmitter. In SFBC, a block of m modulated symbols are coded across n_{f} subcarriers and the coded vectors are simultaneously transmitted from nₜ antennas. The effective transmission rate of such a SFBC is R=m/n_{f}.

In this embodiment, the transmission mode is optimized for a fixed transmission rate and a fixed power. If the transmission rate of the SFBC transmission mode is less than 1 (i.e., R<1), then the modulation order of the SFBC transmission mode should be increased to maintain the constant transmission rate. In this embodiment, the orthogonal SFBC transmission mode achieves very low decoding complexity. Assuming that, within the duration of a symbol, the channel is highly correlated across consecutive subcarriers, a receiver can decode the received symbols with linear complexity. Symbols from each antenna are normalized by 1/\sqrt{n}ₜ), to maintain constant power (i.e., E[∥xₙ∥²]=η). Thus, the received SNR at symbol n is given by

$${γ}_{n} = \frac{η}{{n}_{t}} {‖ {H}_{n} ‖}_{F}^{2} ,$$

where η is average per-symbol SNR. Thus, the received SNR during the first symbol time is given by

$${γ}_{0} = \frac{η}{{n}_{t}} {g}_{0 , sfbc} .$$

The average BER performance of the SFBC transmission mode at symbol n for an M-QAM scheme is then given by:

$${P}_{b}^{bf} ( n , {M}_{n} , {γ}_{0} ) \approx 0.2 {( \frac{3 ( 1 - {ρ}_{n}^{2} ) η}{2 ( {M}_{n} - 1 ) {n}_{t}} + 1 )}^{- {n}_{t} {n}_{r}} exp ( - \frac{3 {ρ}_{n}^{2} {n}_{t} {γ}_{0}}{3 ( 1 - {ρ}_{n}^{2} ) η + 2 ( {M}_{n} - 1 ) {n}_{t}} ) , \qquad ( 8 )$$

and the average BER over a frame at a given SNR η is given by:

$${P}_{b}^{sfbc} ( {γ}_{0} ) \approx \frac{1}{N} {\sum }_{n = 0}^{N - 1} {P}_{b}^{sfbc} ( n , {M}_{n} , {γ}_{0} ) . \qquad ( 9 )$$

In a fast fading channel for which quasi-static assumption does not hold, the BS station may obtain channel information in several ways. For example, in non-reciprocal channels (e.g., in a FDD system) feedback from receivers may be used. Similarly, in reciprocal channels (e.g., in a TDD system) an uplink measurement may be used. The receiver, however, has ready access to channel information at all times. Therefore, at the beginning of a frame, the BS and each MS have channel information (i.e., can determine channel matrix H₀). In addition, the average mobile speed based on the environment can also be used in the design. Consequently, the average BER for both the BF and the SFBC transmission modes can be calculated at both the BS and the MS using equations (6) and (8). Therefore, MIMO transmission modes may be assigned at symbol n based on:

m*(n)=argmin_{mε{bf,sfbc}}P_{b}^{m}(n, Mₙ, γ₀), (10)

where m*(n) is the transmission mode index at symbol n. Alternatively, the BS can inform an MS (e.g., through control information included in a packet header) the initial transmission mode and the criteria for switching modes subsequently. In this manner, both the complexity of implementing the present invention and the probability of error (i.e., the possibility of a mismatch between the BS and MS about a switching point) can be significantly reduced on the MS side.

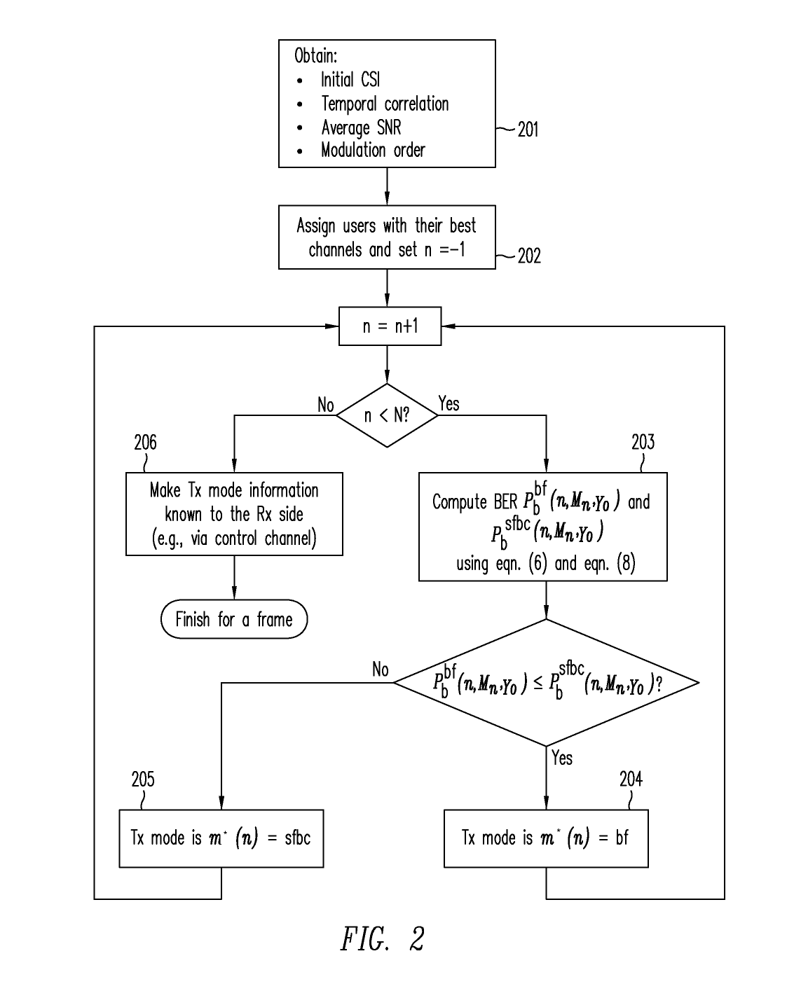

FIG. 2 is a flow chart which illustrates the method described above, in accordance with one embodiment of the present invention. As shown in FIG. 2, at the beginning of each frame (i.e., step 201), a BS obtains CSI, temporal correlation in the channel, average SNR and a modulation order. At step 202, each MS is assigned its best channel (e.g., according to the largest eigenvalue of the channel matrix, or according to the Frobenius norm of the channel matrix). Then, at step 203, for each symbol of the frame, the average BERs for that symbol under both the BF and the SFBC transmission modes are calculated according the equations (6) and (8) above. If the average BER for the BF transmission mode is less than the average BER for the SFBC transmission mode, then the BF transmission mode is selected (step 204). Otherwise, at step 205, the SFBC transmission mode is selected. Due to the performance characteristics of BF and SFBC and the increased degradation of CSI knowledge with time within the transmission frame, the above calculations at each of the symbols can be stopped when the transmission mode switching point (from BF to SFBC) occurs. The transmission modes after the switching point will all be SFBC. The possible choices of transmission modes within a frame are (i) BF for all symbols, if the CSI knowledge is reliable throughout the frame, (ii) SFBC for all symbols, if the CSI knowledge is not reliable enough throughout the frame, or (iii) BF for earlier symbols, with reliable CSI knowledge and SFBC for the remaining symbols, if substantial CSI knowledge degradation occurs within the frame. Then, at step 206, the allocated transmission modes are communicated to the receivers (i.e., the MSs) using a predetermined method, such as over a DL control channel. Under this method, the modulation order Mₙ is fixed throughout the whole frame.

A second method according to one embodiment of the present invention provides an optimization that minimizes average BER. Under this second method, transmission modes are first allocated for the frame based on average BER, similar to the method described above. However, under this second method, CSI knowledge is used only in channel selection, but not in transmission mode allocation. The second method provides modulation order selection for each symbol to allow even higher performance. After allocation of transmission modes, a statistical bit loading algorithm is then carried out to assign modulation orders to each symbol in the frame. Note that channel knowledge is still exploited by BF and channel selection (multiuser and frequency diversity) at the beginning of the frame. Throughout the frame, as the channel decorrelates, channel state information (CSI) becomes outdated and the average received power decreases. Adaptive bit loading may be used to improve performance when channel quality varies. The bit loading algorithm takes advantage of better channel conditions at the beginning of each frame by transmitting at a higher data rate at the beginning of the frame. The optimization problem can be summarized by:

$$( {M}_{1}^{*} , {M}_{2}^{*} , … , {M}_{N}^{*} ) = arg {min}_{( {M}_{1} , {M}_{2} , … , {M}_{N} )} {\sum }_{n = 1}^{N} {P}_{b}^{{m}^{* ( n )} ( n , {M}_{n} )} \\ {2}^{R} = {\sum }_{n = 1}^{N} {M}_{n} \\ {M}_{n} \leq {2}^{{r}_{max}} for n ∈ \{ 1 , 2 , … , N \} , \qquad ( 11 )$$

where Mₙ is the modulation order at the n-th symbol and R is the transmission rate constraint (in number of bits per frame) and rₘₐₓ is the instantaneous rate constraint (in number of bits). A solution to this optimization problem can be found iteratively. An iterative algorithm adds a predetermined number of bits to the frame in each step, such that bits are loaded to the symbol in a manner that causes a minimum increase in BER at each step. The number of bits to be loaded in each step depends on the range of Mₙ. In other words, r bits are loaded in each step, if log₂ (Mₙ) increases in steps of r bits. This algorithm requires the BER expressions to be averaged over the initial channel statistics.

For a MISO system with two or four transmit antennas (i.e., nₜ=2,4, which are of practical importance), this second method may be illustrated by closed-form BER expressions. For nₜ=2, the average BER for a BF transmission mode can be shown to be:

$${P}_{b}^{bf} ( n , {M}_{n} ) \approx 0.2 {{d}_{f} ( \frac{3 ( 1 - {ρ}_{n}^{2} ) η}{2 ( {M}_{n} - 1 )} + 1 )}^{- 1} {\sum }_{k = 0}^{{d}_{f} - 1} {\sum }_{l = 0}^{k} ( \begin{matrix}{d}_{f} - 1 \\ k\end{matrix} ) ( \begin{matrix}k \\ l\end{matrix} ) {( - 1 )}^{k} Γ ( l + 2 ) \times {( \frac{3 {ρ}_{n}^{2} η}{3 ( 1 - {ρ}_{n}^{2} ) η + 2 ( {M}_{n} - 1 ) {n}_{t}} + k + 1 )}^{- ( l + 2 )} , \qquad ( 12 )$$

where δ(•) is the Gamma function and d_{f} is the diversity order due to exploiting frequency and multiuser diversities. The diversity order can be approximated by d_{f}≈Nₜₐₚ with Nₜₐₚ being the number of time domain channel taps. Following similar steps, the corresponding average BER for a SFBC transmission mode is given by:

$${P}_{b}^{sfbc} ( n , {M}_{n} ) \approx 0.2 {{d}_{f} ( \frac{3 ( 1 - {ρ}_{n}^{2} ) η}{2 ( {M}_{n} - 1 ) {n}_{t}} + 1 )}^{- {n}_{t}} {\sum }_{k = 0}^{{d}_{f} - 1} {\sum }_{l = 0}^{k} ( \begin{matrix}{d}_{f} - 1 \\ k\end{matrix} ) ( \begin{matrix}k \\ l\end{matrix} ) {( - 1 )}^{k} Γ ( l + 2 ) \times {( - \frac{3 {ρ}_{n}^{2} η}{3 ( 1 - {ρ}_{n}^{2} ) η + 2 ( {M}_{n} - 1 ) {n}_{t}} + k + 1 )}^{- ( l + 2 )} . \qquad ( 13 )$$

Similarly, for the MISO case with nₜ=4, the average BER for the BF transmission mode is given by:

$${P}_{b}^{sfbc} ( n , {M}_{n} ) \approx 0.2 {{d}_{f} ( \frac{3 ( 1 - {ρ}_{n}^{2} ) η}{2 ( {M}_{n} - 1 )} + 1 )}^{- 1} {\sum }_{k = 0}^{{d}_{f} - 1} {\sum }_{l = 0}^{k} {\sum }_{m = 0}^{k - l} {\sum }_{t = 0}^{t} ( \begin{matrix}{d}_{f} - 1 \\ k\end{matrix} ) ( \begin{matrix}k \\ l\end{matrix} ) ( \begin{matrix}k - l \\ m\end{matrix} ) ( \begin{matrix}l \\ t\end{matrix} ) {( - 1 )}^{k} \times {( \frac{1}{2} )}^{l + 1} {( \frac{1}{3} )}^{t + 1} ( 2 l + m + t + 3 ) ! {( - \frac{3 {ρ}_{n}^{2} η}{3 ( 1 - {ρ}_{n}^{2} ) η + 2 ( {M}_{n} - 1 ) {n}_{t}} + k + 1 )}^{- ( 2 l + m + t + 4 )} , \qquad ( 14 )$$

while the average BER for the SFBC transmission mode is given by:

$${P}_{b}^{sfbc} ( n , {M}_{n} ) \approx 0.2 {{d}_{f} ( \frac{3 ( 1 - {ρ}_{n}^{2} ) η}{2 ( {M}_{n} - 1 ) {n}_{t}} + 1 )}^{- {n}_{t}} {\sum }_{k = 0}^{{d}_{f} - 1} {\sum }_{l = 0}^{k} {\sum }_{m = 0}^{k - l} {\sum }_{t = 0}^{t} ( \begin{matrix}{d}_{f} - 1 \\ k\end{matrix} ) ( \begin{matrix}k \\ l\end{matrix} ) ( \begin{matrix}k - l \\ m\end{matrix} ) ( \begin{matrix}l \\ t\end{matrix} ) {( - 1 )}^{k} \times {( \frac{1}{2} )}^{l + 1} {( \frac{1}{3} )}^{t + 1} ( 2 l + m + t + 3 ) ! {( - \frac{3 {ρ}_{n}^{2} η}{3 ( 1 - {ρ}_{n}^{2} ) η + 2 ( {M}_{n} - 1 ) {n}_{t}} + k + 1 )}^{- ( 2 l + m + t + 4 )} . \qquad ( 15 )$$

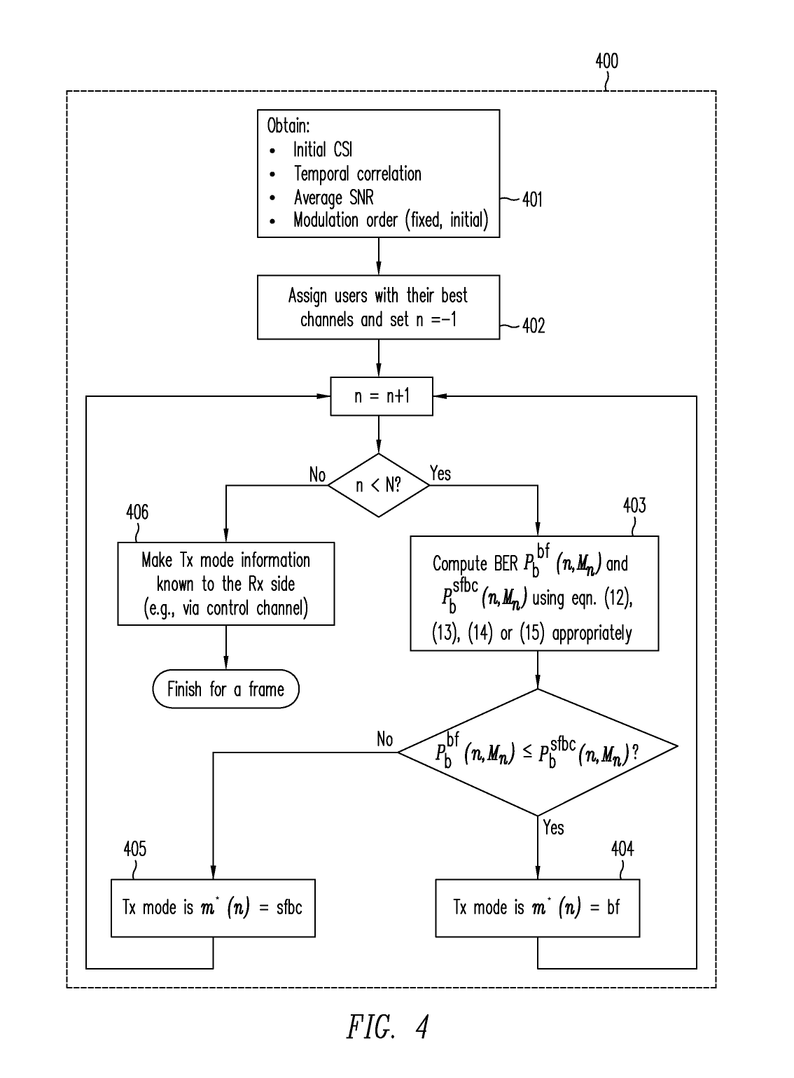

FIGS. 3 and 4 are flowcharts illustrating this second method according to one embodiment of the present invention. Specifically, FIG. 4 shows allocation of MISO transmission modes conditioned upon initial channel knowledge, in the second method in accordance with one embodiment of the present invention. FIG. 3 shows applying a bit loading algorithm after transmission mode allocation, in the second method according to one embodiment of the present invention.

As shown in FIG. 4, at the beginning of each frame (i.e., step 401), a BS obtains CSI, temporal correlation in the channel, average SNR and an initial fixed modulation order. At step 402, each MS is assigned its best channel (e.g., according to the Frobenius norm of the channel matrix). Then, at step 403, for each symbol of the frame, the average BERs for that symbol under both the BF and the SFBC transmission modes are calculated according to the antenna configuration, using the equations (12) or (13) and (14) or (15) above, as appropriate. If the average BER for the BF transmission mode is less than the average BER for the SFBC transmission mode, then the BF transmission mode is selected (step 404). Otherwise, at step 405, the SFBC transmission mode is selected. Selection of transmission modes continues until transmission modes for all N symbols in the frame have been assigned. Then, at step 406, if bit-loading optimization is not required, the allocated transmission modes are communicated to the receivers (i.e., the MSs) using a predetermined method, such as over a DL control channel.

As shown in FIG. 3, at step 301, after allocation of transmission modes of FIG. 4 is completed, transmission data rate information is ascertained. At step 302, the bit-loading optimization (summarized in equation set (11) above) is carried out using, for example, an iterative algorithm. At step 303, the number of bits for each symbol in the frame and the allocated transmission modes are communicated to the receivers (i.e., the MSs) using a predetermined method, such as over a DL control channel.

Given channel temporal correlation, average SNR and diversity order, the transmission modes and modulation orders can be pre-computed offline and provided in a codebook, which can be stored at both the BS and each MS. Alternatively without using a codebook, the BS can communicate the mode and modulation order information to MS via a control channel within the same transmission frame.

Unlike the system disclosed in the Ylitalo patent application mentioned above, the methods of the present invention exploit both multiuser and frequency diversity. Consequently, the methods of the present invention can take advantage of, for example, statistical bit loading across OFDM symbols within the frame. Furthermore, Ylitalo assumes no delay in channel knowledge. In practice, however, some delay is inevitable due to feedback delay, signal processing delay or both, thus causing a performance degradation in Ylitalo's system. Channel knowledge delay can be incorporated in the methods of the present invention. Further, Ylitalo's adaptation criterion is based on SNR, while the adaptation criterion in the methods of the present invention is based on BER.

As discussed above, the present invention adapts even when channel conditions change from symbol-to-symbol. Adaptation without initial channel knowledge may require prohibitively complex optimization techniques, which are impractical for real-time delay sensitive applications. The MIMO switching methods of the present invention, however, allow the transmitter to simply chooses between space-frequency block coding (SFBC) and BF transmission modes based on a calculated average BER for each transmission mode. In high mobility applications, in which channel quality may degrade in the course of a frame, different transmission modes allowed in a single frame achieve the lowest average BERs. Besides multiple antenna transmission modes, the present invention allows data rate to be varied across symbols in a given frame.

The above detailed description is provided to illustrate the specific embodiments of the present invention and is not intended to be limiting. Numerous variations and modifications within the scope of the present invention are possible. The present invention is set forth in the accompanying claims.

We claim:

1. In a wireless communication system including a base station and a plurality of mobile stations, a method for transmitting an orthogonal frequency division multiple access (OFDMA) data frame to the mobile stations, the data frame comprising a plurality of symbols to be transmitted over a plurality of communication channels, the method comprising:
at the beginning of the data frame, collecting metrics representing channel conditions for each of channel;
assigning each mobile station to one or more communication channels based on the metrics collected;
for each symbol in the frame, calculating an average bit-error-rate for each of a plurality of transmission modes, and assigning to that symbol the transmission mode corresponding to the lowest calculated average bit-error-rate for that symbol; and
transmitting the symbols in the frame according to their respective assigned transmission mode.

2. The method of claim 1, wherein the transmission modes comprise a beam-forming transmission mode and a block coding-based transmission mode.

3. The method of claim 2, wherein the block coding-based transmission mode comprises either a space-time block coding transmission mode or a space-frequency block coding transmission mode.

4. The method of claim 1, wherein the average bit-error-rates are calculated according to the antenna configuration.

5. The method of claim 1, wherein the average bit-error-rates are calculated based on the collected metrics.

6. The method of claim 5, wherein the average bit-error-rates are calculated according a decorrelation coefficient based on a model in which the channels de-correlate over the frame.

7. The method of claim 1, wherein the average bit-error-rates are calculated according to a signal-to-noise ratio for each channel at each symbol.

8. The method of claim 1, further comprising communicating the assigned transmission modes to the mobile stations through a control channel allocated in the frame.

9. The method of claim 1, wherein the collected metrics comprise at least one of channel state information, temporal correlation in the channel, average SNR and an initial, modulation order.

10. The method of claim 1, wherein the method transmits the frame at a constant level of total power per frame.

11. The method of claim 1, wherein the method transmit the frame at a fixed data rate.

12. The method of claim 1, wherein each mobile station is assigned a channel based on the eigenvalues of the channel matrices corresponding to the available channels.

13. The method of claim 1, wherein each mobile station is assigned a channel based on the Frobenius norms of the channel matrices corresponding to the available channels.

14. The method of claim 1, further comprising, after assigning transmission modes, determining a data rate for transmitting the frame.

15. The method of claim 14, wherein a bit-loading optimization step is carried out to determine a modulation order for each symbol.

16. The method of claim 14, wherein the modulation order relates to a quadrature amplitude modulation scheme.
